(19) United States
(12) Patent Application Publication
(10) Pub. No.: US 2008/0116122 A1
(43) Pub. Date: May 22, 2008

(54) Chromatography systems comprising single-use components

(75) Inventors: Scott M. Wheelwright, Saratoga, CA (US); Steven Schamow, San Mateo, CA (US); Ed Louie, Belmont, CA (US); Andrew T. Zander, Santa Barbara, CA (US)

Correspondence Address: MEDLEN & CARROLL, LLP, 101 HOWARD STREET, SUITE 350, SAN FRANCISCO, CA, 94105, US

(73) Assignee: Genitope Corporation, Fremont, CA (US)

(21) Appl. No.: 11/827,925

(22) Filed: Jul. 13, 2007

Related U.S. Application Data
(63) Continuation of application No. 11/603,756, filed on Nov. 22, 2006, now abandoned.

(51) Int. Cl. B01D 15/08; B01D 15/10

(52) U.S. Cl. 210/87; 210/143; 210/198.2; 210/85; 210/90

(57) ABSTRACT

The present invention relates to single-use chromatography devices and systems for use with a durable component for processing compounds such as protein compounds.

This application is a continuation of co-pending U.S. patent application Ser. No. 11/603,756, filed Nov. 22, 2006, which is incorporated herein by reference.

### FIELD OF THE INVENTION

The present invention relates to liquid chromatography (LC) devices and systems comprising a durable component and a single-use component. In particular, the present invention provides a single-use chromatography component comprising a tubing harness comprising a chromatography column and, in some embodiments, a detection flow cell, for use with a durable component comprising a peristaltic pump and a valve system for the efficient purification of patient-specific biological products, e.g., for therapeutic use.

### BACKGROUND OF THE INVENTION

Proteins are often processed using a liquid chromatography or “LC” system. Existing LC systems comprise high precision, durable components that must be cleaned between uses. There remains a need for improved chromatography systems, e.g., for process purifications.

### SUMMARY OF THE INVENTION

The present invention provides a liquid chromatography system in which the entire fluid flow path, including the separation column and the detection flow cell, is disposable after a single use.

In some embodiments, the chromatography system of the present invention comprises a durable component and a single-use component, wherein the durable component comprises a peristaltic pump and a pinch valve, and wherein the single-use component comprises a tubing harness comprising a plurality of reagent inlets, a fluid outlet, and a chromatography column. In some preferred embodiments, the tubing harness further comprises a pressure sensor.

In some embodiments, the chromatography system of the present invention comprises a tubing harness further comprising a pH sensor, while in some embodiments, the tubing harness further comprises a conductivity sensor. In some embodiments, the tubing harness further comprises a detection flow cell. In preferred embodiments, the detection flow cell comprises a UV detection flow cell.

In some embodiments of the chromatography system of the present invention, the durable component comprises a single peristaltic pump. In some embodiments, the durable component further comprises a centralized control system. In some embodiments, the centralized control system controls at least one valve of the durable component. In preferred embodiments, the valve is a pinch valve. In particularly preferred embodiments, the centralized control system controls a pinch valve system comprising a plurality of pinch valves. In some embodiments, the centralized control system controls the peristaltic pump.

In some embodiments, the durable component of the chromatography system further comprises an optical detector. In preferred embodiments, the optical detector detects in a light range comprising the UV range. In some embodiments, the durable component further comprises a pH sensor, and in some embodiments, the durable component further comprises a conductivity sensor.

In some embodiments, the present invention provides a single-use component for a chromatography system comprising a tubing harness, wherein the tubing harness comprises a plurality of reagent inlets, a fluid outlet, and a chromatography column. In some embodiments, the tubing harness further comprises a pressure sensor.

In some embodiments, the single-use component of the present invention comprises a tubing harness comprising a pH sensor, while in some embodiments, the tubing harness comprises a conductivity sensor. In some embodiments, the tubing harness comprises a detection flow cell. In preferred embodiments, the detection flow cell comprises a UV detection flow cell.

### DESCRIPTION OF THE DRAWINGS

FIG. 1 provides a schematic diagram of an embodiment of the single-use liquid chromatography system of the present invention. Chromatography system A comprises sample reservoirs 1, buffer reservoirs 2, connectors 3, reagent inlets 4, tubing harness 5, peristaltic pump 6, pressure sensor 7, valves 8, chromatography column 9, UV detection flow cell 10, pH sensor 11, product receiver 12, and waste receiver 13.

FIG. 2 provides a schematic diagram of an embodiment of the single-use liquid chromatography system of the present invention. Chromatography system A comprises sample reservoir 1, buffer reservoirs 2, connectors 3, reagent inlets 4, tubing harness 5, peristaltic pump 6, pressure sensor 7, valves 8, chromatography column 9, UV detection flow cell 10, conductivity sensor 14, product receiver 12, and waste receiver 13.

### DEFINITIONS

The term “chromatography” as used herein includes any molecular separation technique that involves a molecule or molecules interacting with a matrix. The matrix may take the form of solid or porous beads, resin, particles, membranes, or any other suitable material. Unless otherwise specified, chromatography includes both flow-through and batch techniques.

The term “chromatography column” as used herein refers to a component containing a chromatography matrix, and configured such that a mobile phase, e.g., a fluidic sample or buffer, can pass through the column, thereby passing through the matrix retained in the column.

The term “durable” as used herein in reference to the chromatography system of the present invention refers to parts or components of the system that are permanent or semi-permanent, i.e., that are intended for re-use multiple times in conjunction with replaceable single-use components.

The term “single-use” as used herein in reference to components of the chromatography system refers to components that are configured to be replaced or discarded after each use, and that are not intended to be re-used in the system.

The term “tubing harness” as used herein refers to a component comprising an arrangement of one or more tubing components (e.g., sections of tubing) configured to provide fluidic connection between at least two points of entry into a fluidic system (e.g., reagent inlets) and one or more points of exit from the system (e.g., into a product receiver and/or waste receiver). The tubing harness defines a flow path for fluid therein.

In some embodiments, a tubing harness further comprises additional elements, such as a chromatography column, one or more sensors, and one or more detection flow cells.

The term “reagent inlet” as used herein in reference to a tubing harness refers to a point at which fluid (e.g., sample or buffer) enters the flow path.

The term “fluid outlet” as used herein in reference to a tubing harness refers to a point at which fluid (e.g., processed product or waste fluid) exits the flow path, e.g., into a product receiver or waste receiver.

The term “flow path” as used herein refers to a fluidic path through which a fluid, e.g., a protein sample or buffers, flows, from a point of entry into tubing or a tubing harness (e.g., at one or more reagent inlets) to a point of exit from the tubing or tubing harness (e.g., into a product receiver or waste receiver).

The term “flow cell” as used herein, refers to a cell, such as a detection cell, configured to allow sample or fluid to flow through the cell so as to allow continuous exchange of sample within the cell during operation of the cell e.g., during detection. Use of a flow cell allows, for example, continuous analysis of the fluid that is proceeding through a flow path.

The term “detection flow cell” as used herein refers to a flow cell configured to allow detection of or analysis of fluid in a flow path.

The term “UV detection cell” as used herein refers to a detection flow cell configured to allow UV (ultra violet radiation absorption)-based optical detection (e.g., a flow cell comprising a UV-grade window) of fluid in a flow path.

The term “centralized control system” as used herein refers to information and equipment management systems (e.g., one or more computer processors and computer memory; or a programmable logic controller (PLC) linked to a human-machine interface (“HMI,” e.g., a keypad, key board, control panel, lever, button, etc.) and computer memory) operably linked to or integrated into a component or components of equipment (e.g., a computer system operably linked to one or more components or operable elements of an LC system).

The terms “processor” and “central processing unit” or “CPU” are used interchangeably herein and refer to a device that is able to read a program from a computer memory (e.g., ROM or other computer memory) and perform a set of steps according to the program.

The terms “computer memory” and “computer memory device” as used herein refer to any storage media readable by a computer processor. Examples of computer memory include, but are not limited to, RAM, ROM, computer chips, digital video disc (DVDs), compact discs (CDs), hard disk drives (HDD), flash (solid state) recording media and magnetic tape.

The terms “a” or “an” as used as an indefinite article in reference to a component of the chromatography system of the present invention (e.g., “a pinch valve”) means at least one of the recited component.

### DESCRIPTION OF THE INVENTION

Liquid chromatography (LC), whether used for high-pressure or low-pressure separations, is considered optimally operational when precise operating conditions are used. These conditions are typically met by the use of fixed, non-disposable, precision components, such as flow-through valves, metal tubing, piston pumps, and low dead-volume sampling inputs.

The present invention provides an LC system comprising a single-use tubing harness comprising a flow path that, in conjunction with a durable system comprising a pump and a valve, performs to sufficient operational characteristics for process purifications to be performed without the need for the non-disposable precision components that make up the flow path of a standard LC system. It has been found that the highly precise and accurate operating parameters of conventional LC are not required for an LC that is used for certain protein purification processes, such as non-quantitative purification processes.

The LC system of the present invention comprises: 1) a single-use component comprising a tubing harness that is disposable after use, and 2) a durable (non-disposable) component that controls the movement of fluid in the flow path. The durable component also monitors the fluid during the process, yet has little or no contact with the fluid being processed, and has no contact with the fluid that is destined to be part of the final product.

The LC systems of the present invention are particularly useful in the production of biological materials for therapeutic use. For example, some therapeutic proteins are derived from patient materials, and are for use only in the patient from whom they were derived. See, e.g., U.S. Pat. Nos. 5,776,746 and 5,972,334, incorporated herein by reference, for examples of recombinant production of proteins derived from a patient's tumor, for use in treating the patient from whom the protein was derived. Production of such protein products generally requires purification through a process such as a liquid chromatography process. Existing production-scale chromatography systems may comprise one or a few disposable components (e.g., disposable columns), but they generally also comprise many components of durable construction (i.e., non-disposable) that come into direct contact with the patient-specific sample being processed, i.e., they are in contact with the flow path of the system. If such a chromatography system is used in the purification of a patient-specific compound, the entire fluid path of the equipment must be cleaned using a validated cleaning method prior to use with materials from another patient. Validated cleaning steps are costly and time consuming. The LC system of the present invention allows purification of a patient-specific compound without the need to clean the fluid path of the equipment using a validated cleaning method prior to use with materials from another patient.

While the present invention is described with reference to several specific embodiments, the description is illustrative of the present invention and is not to be construed as limiting the invention. Various modifications to the present invention can be made without departing from the scope and spirit of the present invention.

### A. Single-Use Component

A single-use component according to the present invention is configured such that the entire fluid flow path between the sample application point and the sample collection point, including the separation column, is disposable after a single use. The single-use component of the present invention comprises a tubing harness comprising at least one chromatographic separation column. The tubing harness of the present invention is generally loaded or fitted onto the durable component prior to use, and is generally discarded, e.g., as medical waste, after use. Single-use chromatography columns suitable for low-pressure LC separations, e.g., of proteins, are well known. Examples of single-use chromatography columns for low-pressure LC separations that find use in the present invention include, but are not limited to, the Mustang™ high throughput pleated unit capsules and cartridges for ion exchange chromatography (Pall, Inc., East Hills, N.Y.) and the Histidine SpinTrap prepacked spin column for bench-top purification (GE Healthcare, Inc., Westborough, Mass.)

In some embodiments, the tubing harness comprises flexible plastic tubing components. In preferred embodiments, the tubing components of the tubing harness comprise flexible medical-grade tubing. In some embodiments, the tubing components of the tubing harness comprise plastic, including but not limited to flexibilized polyvinyl chloride (PVC), polyethylene, nylon, polyurethane, thermoplastic (styrene-, propylene- and urethane-based) elastomers, silicone and fluoropolymers. In particularly preferred embodiments, the tubing components of the tubing harness comprise TYGON® LFL Tubing, (United States Plastics Corporation, Lima, Ohio), and C-FLEX Tubing (Masterflex®, Cole-Parmer, Inc., Vernon Hills, Ill.) In some embodiments, transparent tubing components are used, e.g., to allow visual inspection of fluid in the flow path, while in other embodiments, opaque tubing components are used, e.g., to shield the sample materials in the flow path from light.

In preferred embodiments, tubing is selected such that its durometer (the surface resistivity, or material hardness) matches the operational demands of an electronic pinch valve (as discussed in more detail in the discussion of the durable component, below). In particularly preferred embodiments, e.g., when Solenoid Valve-Tubing Pinch Valves N/C, Model 958V8547 (ACRO Associates, Inc., Concord, Calif.) are used, it is preferred that the harness is made from TYGON® LFL tubing, Type LS-14 with an inner diameter of 1/16″.

In preferred embodiments, the tubing harness of the LC system of the present invention has a low coefficient of friction, e.g., to facilitate flow and to withstand fluid flow pressures. In particularly preferred embodiments, the tubing components of the tubing harness are biocompatible and are inert in contact with fluids being processed. In some preferred embodiments, the tubing components used in tubing harness are plasticizer-free. Preferred tubing components can be sterilized, e.g., by radiation, steam, ethylene oxide, or chemical methods.

In some embodiments, the tubing harness comprises a pressure sensor. Pressure sensors that find use in the present invention include, but are not limited to, TransPac® IV (Abbott Critical Care Systems, Abbott Park, Ill.), NAMIC® Perceptor® DT (Boston Scientific, Inc., Natick, Mass.) and TranStar® MX950, (Medex, Inc. Carlsbad, Calif.)

In some embodiments, the tubing harness comprises one or more flow cells. In preferred embodiments, the tubing harness comprises a detection flow cell such as an optical detection flow cell. In particularly preferred embodiments, the tubing harness comprises a novel single-use detection flow cell made of plastic and comprising inexpensive UV-grade windows. In particularly preferred embodiments the detection flow cell is made from USP Grade VI polycarbonate plastic, and comprises UV-grade windows, e.g., UV-grade quartz windows (Technical Glass Products, Inc. Painesville Township, Ohio). It is contemplated that, for applications in which the optical signals detected are not being used for quantitative analysis, e.g., during process purification of manufactured proteins, the UV-grade quartz windows need not be rigidly and highly precisely located with respect to each other, or to the optical beam of the optical detector. This is in contrast to standard quantitative applications of UV optical measurements, which require high-precision optical configurations and therefore generally require expensive flow cells or cuvettes.

In some embodiments, the tubing harness is configured to be used with a a pH or conductivity sensor, e.g., to detect the pH or conductivity of fluid at one or more particular locations in the LC system. In some embodiments, the tubing harness of the present invention provides one or more access points through which sensors, e.g., pH and/or conductivity sensors, can have direct contact with fluid in the flow path. The tubing harness of the present invention is not limited by the nature or location of the access points. In some embodiments, an access point for a pH or the conductivity sensor is positioned in a portion of tubing leading to the waste receiver, while in some embodiments, an access point for a pH or the conductivity sensor is positioned in a portion of tubing leading to the product receiver.

In some embodiments, the tubing harness of the present invention comprises pH and/or conductivity sensors. In embodiments in which the pH or the conductivity sensor is positioned to determine the pH or the conductivity of fluid flowing to the product receiver, it is preferable to use pH or conductivity sensors that are single-use devices, e.g., that are provided as components of the tubing harness. Single-use pH and conductivity sensors that find use in the system of the present invention include but are not limited to the Applikon Single-Use Miniaturized pH Sensor, #ZZ2, and the Applikon Single-Use Miniaturized Conductivity Sensor, #ZZ1 (Applikon USA, Inc., Foster City, Calif.)

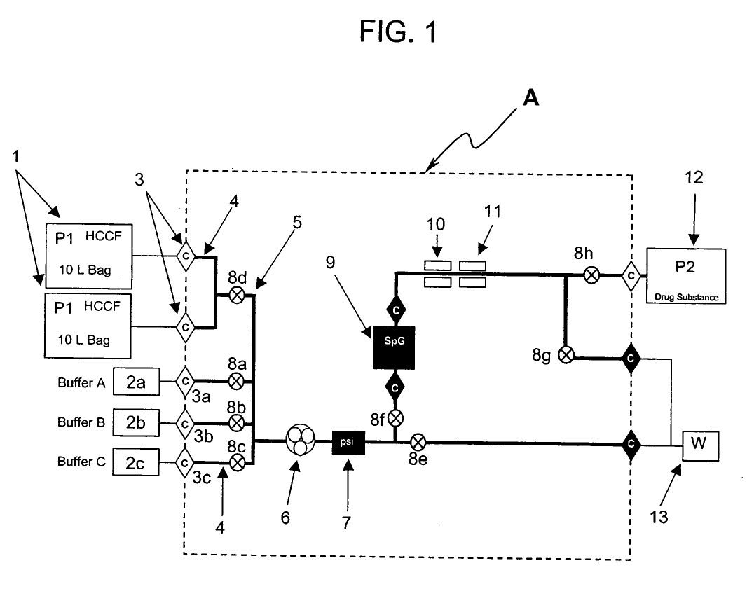

In some embodiments, the tubing harness is manufactured to provide a single piece, i.e., the connections between tubing components, chromatography column, and any other components are essentially permanent. In other embodiments, the components of the tubing harness comprise attachable connectors such that the tubing harness can be assembled from separate single-use components. The use of attachable connectors is especially useful when, for example, different components of the tubing harness (e.g., the tubing components and the chromatography column) are to be sterilized using different sterilization methods. See, e.g., FIG. 1 for one embodiment of a tubing harness comprising attachable connectors (shown as solid black diamonds) between different components of the tubing harness. In preferred embodiments, the attachable connectors permit attachment of the sterile components under conditions in which the sterility of the flow path is maintained. In some embodiments, the attachable connectors are also detachable.

In some embodiments, the tubing harness comprises attachable connectors for attachment of input reservoirs (e.g., containers for supplying sample, such as harvested cell culture fluid (HCCF) and/or buffers used in conducting the chromatographic process). In some embodiments, the tubing harness further comprises attachable connectors for attaching output receivers such a product receiver and/or a waste receiver. In other embodiments, the tubing harness further comprises an integrated waste receiver (e.g., a waste receiver that is permanently attached to said tubing harness prior to use).

### B. Durable Component

The durable component generally comprises non-disposable functional elements designed to interact with the single-use component to perform a liquid chromatography process operation. Frameworks for mounting the elements of the durable component are known. In preferred embodiments, the elements of the durable component are mounted, either permanently or removably, on a skid.

Peristaltic pumps are well-known components for fluid flow systems, but even precision peristaltic pumps have conventionally been considered inappropriate or inadequate for the demands of fluid pumping in liquid chromatography. This is because peristaltic pumps do not provide the pressure stability and fluid flow continuity needed for higher performance chromatographic applications. The pulsating flow that a peristaltic pump provides disrupts the separation process, adding noise to the system and causing elution peak broadening. Consequently, conventional LC systems generally use multiple, tightly toleranced, highly quantitative, and highly pressure-stable pumps, usually of the piston or displacement variety.

The present invention provides a simplified instrument having increased reliability through minimization of active components. In contrast to conventional LC systems, in the LC system of the present invention, use of a precision peristaltic pump in combination with high quality but conventional flexible tubing in the tubing harness, and along with computerized control of the valve operation and pumping parameters, provides the necessary precision of pumping and pressure control for certain protein purification processes, such as non-quantitative purifications.

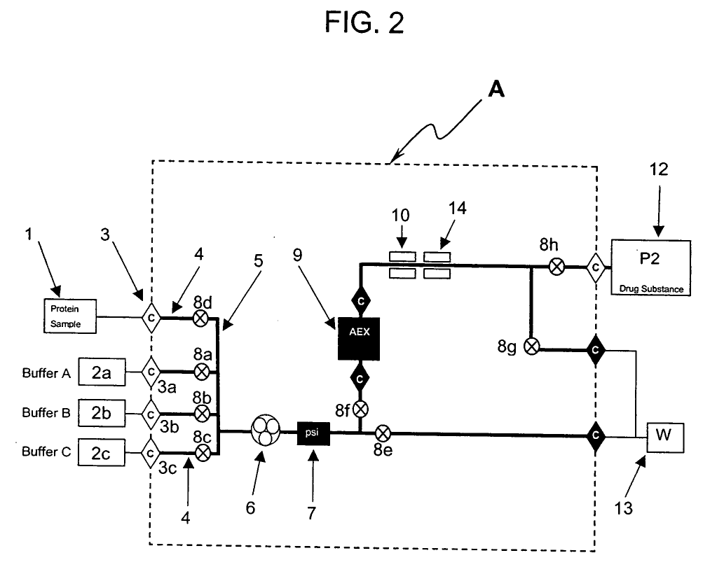

As used herein, the term “peristaltic pump” refers to a pump that propels the flow of material through a flexible tube or tubing system (e.g., a tubing harness of the present invention) without requiring an opening or breach in the tubing, and without forming direct contact with the materials contained in the tubing. For example, common peristaltic pumps propel fluid or other materials through flexible tubing by the use of sequential and directional compressions of the tubing. It is an aspect of the invention that the pump does not come in direct fluid contact with the fluid material in the flow path. In preferred embodiments of the present invention (e.g., as diagrammed in FIGS. 1 and 2) the durable component of the LC system comprises a single peristaltic pump. The present invention is not limited by the particular peristaltic pump used. Peristaltic pumps that find use in the present invention include but are not limited to pumps such as the MasterFlex® L/S Positive Displacement Peristaltic Pump, Cole-Parmer, Vernon Hills, Ill.

In some embodiments, the peristaltic pump is under control of a central control system. The present invention is not limited by the type of central control system used. Controllers that find use in the present invention include but are not limited to controllers such as the Allen-Bradley Micrologix® 1100 Programmable Controller with RDLogix® 500 software linked to an Allen-Bradley VersaView®CE computer running RSView®software. In preferred embodiments, the central control system controls the flow parameters in the tubing harness by coordinately controlling the speed of the peristaltic pump and a plurality of pinch valves. In some preferred embodiments, the central control system comprises a program that determines the volumes of fluids that have been pumped (e.g., that have flowed past a given point in the tubing harness). In particularly preferred embodiments, the determinations of volumes pumped comprise calculations based on the relation of pump rotation rate and tubing diameter to the flow volume.

In some embodiments, the durable component comprises one or more valves, such as pinch valves, to control the flow of fluids through the flow path. As used herein, the term “pinch valve” refers to any valve that can alter the flow through a flexible tube or tubing system without requiring an opening or junction in the tubing system, and without forming direct contact with the materials contained in the tubing. For example, common pinch valves operate by compressing flexible tubing to restrict or stop flow through the tubing.

In some embodiments, one or more pinch valves are controlled by a centralized control system. Examples of controllable pinch valves that find use in the present invention include, but are not limited to, the Solenoid Valve-Tubing Pinch Valve N/C, Model 958V8547 (ACRO Associates, Inc., Concord, Calif.). In preferred embodiments, pluralities of pinch valves are coordinately controlled by a centralized control system to form a valve system. In particularly preferred embodiments, the selection of which solution to pump at a given time is controlled by the coordinated opening and/or closing of pinch valves within a valve system (e.g., to open and close reagent inlets between a tubing harness and particular fluid reservoirs). In particularly preferred embodiments, the coordinate actuation of pinch valves allows all pumping in the LC system to be performed using a single peristaltic pump. Conventional LC systems typically select solutions to be pumped by activating pumps located at each solution reservoir, thereby increasing the equipment complexity of the system. The use of a single peristaltic pump is advantageous, e.g., by providing a simpler, lower cost system, for the process LC applications suitable for use with the LC system of the present invention.

In some embodiments, the durable component of the LC system of the present invention comprises a detector configured to detect materials in a detection flow cell. In preferred embodiments, the detector is an optical detector. In particularly preferred embodiments, the optical detector detects in a light range comprising the UV range, and is configured to detect materials in a single-use detection flow cell in a single-use tubing harness of the present invention. Examples of optical detectors that find use in the present invention include, but are not limited to, Model AF44 UV Inline Sensor with Model 762 UV Monitor (Wedgewood Associates, Inc., Anaheim, Calif.), Model AF45-S21-280 High Performance UV Absorption Sensor with OEM UV Absorption System 01-24V (optek-Danulat, Inc., Germantown, Wis.) and the PurSpec In-Line WV Spectrophotometer (EnVision Instruments, Issaquah, QA).

In some embodiments, the durable component comprises a pH or conductivity sensor, e.g., to detect the pH or conductivity of fluid at a particular location in the LC system. In some embodiments, the durable component comprises both a pH sensor and a conductivity sensor. In some embodiments, the tubing harness of the present invention provides an access point at which a pH or a conductivity sensor can have direct contact with fluid in the flow path. pH and conductivity sensors that find use in the system of the present invention include, but are not limited to, the Mettler-Toledo InLabe® 413 (Mettler-Toledo, Inc., Columbus, Ohio), the MicroFlow pH Sensor (Broadley-James, Inc., Irvine, Calif.), the Mettler-Toledo InLab® 730 Conductivity Sensor (Mettler-Toledo, Inc., Columbus, Ohio), or the Wedgewood Analytical BT721 Conductivity Sensor (Wedgewood Analytical, Inc., Anaheim, Calif.)

In embodiments in which a pH sensor or conductivity sensor is provided as part of the durable component of the LC system, it is preferred that the pH or the conductivity sensor is positioned to determine the pH or the conductivity of fluid flowing to the waste receiver. In such embodiments, although the pH or conductivity sensor is a durable component that touches the patient-specific product, the sensor is not required to be cleaned in a validated manner because it only touches waste flow. Thus, the pH or conductivity sensor does not touch any fluid flowing to the product receiver. pH or conductivity sensor is generally cleaned in a routine manner after each use in order to ensure proper measurement operation.

### EXAMPLE 1

An exemplary embodiment of the LC system of the present invention is diagrammed in FIG. 1. LC system A comprises a durable component comprising a plurality of pinch valves 8 (shown as 8a-8h) and a peristaltic pump 6. In preferred embodiments, the contacts between the durable component and the single-use component do not generally require opening of the flow path for placing the single-use component in an operational configuration with respect to the durable component. For example, the peristaltic pump 6 and the pinch valves 8 of the durable component of LC system A comprise openings that allow a fully assembled tubing harness to be placed it its operational position without disconnection of any detachable connectors of the tubing harness 5. In the embodiment shown, when a pH sensor 11 (or conductivity sensor 14) is used, the sensor has direct access to the fluid path via an access point in the portion of the tubing harness 5 leading to the product receiver 12. A tubing harness 5 containing the flow path is shown by the heavy black lines.

Connectors 3 forming fluidic connections between components of the tubing harness and between the harness and input reservoirs 1 and 2a-2c, waste receiver 13 and product receiver 12, are shown as diamonds. Connectors for making fluidic connections are well known. For example, ChemQuick™ Quick Disconnect Couplings (CPC, Inc.), or Plastic Luer Fittings, (Cole-Parmer, Vernon Hills, Ill. 60061) are suitable for use in the single-use component of the present invention. As noted above, in some embodiments the connectors 3 are attachable connectors that allow the tubing harness 5 to be assembled from components that have been sterilized using different sterilization methods, or have been otherwise processed as separate pieces.

In the embodiment shown in FIG. 1, input reservoirs 1 contain sample for processing and input reservoirs 2a-2c contain buffers for use in the chromatographic protocol. These input reservoirs are attached to the reagent inlets 4 of tubing harness 5 by connectors 3.

To purge the flow path of air and prime the fluid lines, the pumping action of peristaltic pump 6 draws Buffer B in reservoir 2b through connector 3b and through a reagent inlet 4 into tubing harness 5. With pinch valves 8b and 8e open and all other valves are closed, Buffer B is propelled through the pressure sensor 7, and into the waste receiver 13.

To pre-elute the chromatography column 9, valves 8b, 8f and 8g are open and all other valves are closed so that Buffer B, once drawn into tubing harness 5 through connector 3b and through reagent inlet 4, is propelled through the pressure sensor 7, then through chromatography column 9, through the UV detector flow cell 10, and through the pH sensor 11, then into the waste receiver 13.

To equilibrate chromatography column 9, valves 8a, 8f and 8g are open and all other valves are closed such that the pumping action of peristaltic pump 6 draws Buffer A in reservoir 2a through connector 3a and through a reagent inlet 4 into tubing harness 5. Buffer A is then propelled through the pressure sensor 7, then through chromatography column 9, through the UV detector flow cell 10, and through the pH sensor 11, then into the waste receiver 13.

To load the sample material from reservoir 1 (harvested cell culture fluid, or “HCCF”), valves 8d, 8f and 8g are open and all other valves are closed such that the pumping action of peristaltic pump 6 draws the HCCF in sample reservoir(s) 1 through connector(s) 3 and through a reagent inlet 4 into tubing harness 5. Multiple sample reservoirs 1 may be employed. The HCCF is then propelled through the pressure sensor 7, then through chromatography column 9, through the UV detector flow cell 10, and through the pH sensor 11, then into the waste receiver 13.

To wash chromatography column 9 following the loading of the HCCF, valves 8a, 8f and 8g are open and all other valves are closed such that the pumping action of peristaltic pump 6 draws Buffer A in reagent reservoir 2a through connector 3a and through a reagent inlet 4 into tubing harness 5. Buffer A is then propelled through the pressure sensor 7, then through chromatography column 9, through the UV detector flow cell 10, and through the pH sensor 11, then into the waste receiver 13.

To elute product from chromatography column 9, valves 8b, 8f and 8h are open and all other valves are closed so that Buffer B, once drawn into tubing harness 5 through connector 3b and through reagent inlet 4, is propelled through the pressure sensor 7, then through chromatography column 9, through the UV detector flow cell 10, and through the pH sensor 11, and into the product receiver.

To strip chromatography column 9 after elution, valves 8c, 8f and 8g are open and all other valves are closed such that the pumping action of peristaltic pump 6 draws Buffer C in reagent reservoir 2c through connector 3c and through a reagent inlet 4 into tubing harness 5. Buffer C is then propelled through the pressure sensor 7, then through chromatography column 9, through the UV detector flow cell 10, and through the pH sensor 11, then into the waste receiver 13.

It will be appreciated that these individual steps can be rearranged in order or repeated, or additional steps, samples and/or buffers may be employed as appropriate for any particular sample processing (loading and elution) desired.

All control parameters, such as step timing, flow rate, volumes, and signal threshold, can be set by the operator (e.g., in the HMI of a central control system, in particular) in advance of a run. When a run is initiated, the central control system controls all aspects of the run operations and collects such data as is determined by the user-defined protocol. As desired, the central control system further generates a data file, e.g., for download to a data manipulation computer after the run.

In a preferred embodiment, the system is assembled and made to perform a chromatographic separation-based purification of a protein product. All fluid contact surfaces are joined together into a tubing harness containing a single integrated flow path that is easily inserted onto the device (the durable component). The cell culture product and all solutions necessary for chromatographic purification passed through the flow path without contact with any other surface until reaching the multiple exit ports, product receiver containers or waste receiver containers. HCCF input sample and buffer solutions are provided in single-use bags, bottles or other suitable containers that are attachable to the connectors of the tubing harness. Protein product and waste streams are similarly collected in single-use containers.

Flow of a selected buffer or HCCF into and through the flow path of the tubing harness is controlled by means of individually actuated pinch valves directing flow to a peristaltic pump designed to meet the system backpressure requirements. In this particular embodiment, these requirements include a 20 mL chromatographic column as well as a pressure transducer, UV detection flow cell and other related components such as pH or conductivity sensors. In preferred embodiments, the components of the tubing harness, e.g., the tubing components, are specifically selected to accommodate system pressure and flow rate requirements for any given system configuration and application.

The device includes provision for monitoring the solution as it flows through the flow path with sensing devices, including those that monitor such characteristics as ultraviolet radiation absorption, conductivity, pH and pressure.

In the embodiment shown in FIG. 1, the automation design is for an automated “start to finish” process. The four inlet valves are used sequentially to deliver buffers and HCCF to the column. The system monitors UV absorption of the fluid to determine when to collect product through the product outlet pinch valve 8h. At all other times the fluid is directed to the waste receiver 13.

### EXAMPLE 2

Another exemplary embodiment of the LC system of the present invention is diagrammed in FIG. 2. The system of FIG. 2 is assembled and made to perform a chromatographic ion exchange separation-based purification of a protein product that has been partly purified, and adjusted for pH and conductivity levels. This step removes residual DNA from the partly purified protein. All fluid contact surfaces are joined together into a tubing harness containing a single integrated flow path that is easily inserted onto the device (the durable component). The partly purified product and all solutions necessary for chromatographic purification pass through the flow path without contact with any other surface until reaching exit ports such as the product receiver containers or waste receiver containers. Partly purified protein input sample and buffer solutions are provided in single-use bags, bottles or other suitable containers that are attachable by connectors to the reagent inlets of the tubing harness. Protein product and waste streams are similarly collected in single-use containers.

Flow of a selected buffer or partly purified protein into and through the flow path of the tubing harness is controlled by means of individually actuated pinch valves directing flow to a peristaltic pump designed to meet the system backpressure requirements. In this particular embodiment, these requirements include a 5 mL chromatographic column as well as a pressure transducer, UV detection flow cell and other related components such as conductivity sensors. In this embodiment, the components of the tubing harness, e.g., the tubing components, are specifically selected to accommodate system pressure and flow rate requirements for the given system configuration and application.

In the embodiment shown in FIG. 2, input reservoir 1 contains sample for processing and input reservoirs 2a-2c contain buffers for use in the chromatographic protocol. These input reservoirs are attached to the reagent inlets 4 of tubing harness 5 by connectors 3.

To purge the flow path of air and prime the fluid lines, the pumping action of peristaltic pump 6 draws Buffer B in reservoir 2b through connector 3b and through a reagent inlet 4 into tubing harness 5. With pinch valves 8b and 8e open and all other valves are closed, Buffer B is propelled through the pressure sensor 7, and into the waste receiver 13.

To pre-elute the chromatography column 9, valves 8b, 8f and 8g are open and all other valves are closed so that Buffer B, once drawn into tubing harness 5 through connector 3b and through reagent inlet 4, is propelled through the pressure sensor 7, then through chromatography column 9, through the UV detector flow cell 10, and through the conductivity sensor 14, then into the waste receiver 13.

To equilibrate chromatography column 9, valves 8a, 8f and 8g are open and all other valves are closed such that the pumping action of peristaltic pump 6 draws Buffer A in reservoir 2a through connector 3a and through a reagent inlet 4 into tubing harness 5. Buffer A is then propelled through the pressure sensor 7, then through chromatography column 9, through the UV detector flow cell 10, and through the conductivity sensor 14, then into the waste receiver 13.

To run the sample material from reservoir 1 (partly purified protein) through the ion exchange column 9, valves 8d, 8f and 8h are open and all other valves are closed such that the pumping action of peristaltic pump 6 draws the protein in sample reservoir 1 through connector 3 and through a reagent inlet 4 into tubing harness 5. The protein is then propelled through the pressure sensor 7, then through chromatography column 9, through the UV detector flow cell 10, and through the conductivity sensor 14, then into the product receiver 12.

To wash chromatography column 9 following the flow through of the partly purified protein, valves 8a, 8f and 8g are open and all other valves are closed such that the pumping action of peristaltic pump 6 draws Buffer A in reagent reservoir 2a through connector 3a and through a reagent inlet 4 into tubing harness 5. Buffer A is then propelled through the pressure sensor 7, then through chromatography column 9, through the UV detector flow cell 10, and through the conductivity sensor 14, then into the waste receiver 13.

To strip chromatography column 9 after the removal of residual DNA, valves 8c, 8f and 8g are open and all other valves are closed such that the pumping action of peristaltic pump 6 draws Buffer C in reagent reservoir 2c through connector 3c and through a reagent inlet 4 into tubing harness 5. Buffer C is then propelled through the pressure sensor 7, then through chromatography column 9, through the UV detector flow cell 10, and through the conductivity sensor 14, then into the waste receiver 13.

In this embodiment, the system is assembled and made to perform a chromatographic separation-based purification of a protein product. All fluid contact surfaces are joined together into a tubing harness containing a single integrated flow path that is easily inserted onto the device (the durable component). The partly purified product and all solutions necessary for chromatographic purification passed through the flow path without contact with any other surface until reaching the multiple exit ports, product receiver containers or waste receiver containers. Partly purified protein input sample and buffer solutions are provided in single-use bags, bottles or other suitable containers that are attachable to the connectors of the tubing harness. Protein product and waste streams are similarly collected in single-use containers.

The device includes provision for monitoring the solution as it flowed through the flow path with sensing devices, including those that monitor such characteristics as ultraviolet radiation absorption, conductivity, pH and pressure.

In the embodiment shown in FIG. 2, the automation design is for an automated “start to finish” process. The four inlet valves are used sequentially to deliver buffers and partly purified protein to the column. The system monitors UV absorption of the fluid to determine when to collect product through the product outlet pinch valve 8h. At all other times the fluid is directed to the waste receiver 13.

All publications and patents mentioned in the above specification are herein incorporated by reference. Various modifications and variations of the described methods, components, and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in protein purification, engineering, or related fields are intended to be within the scope of the following claims.

We claim:

1. A chromatography system comprising a durable component and a single-use component, wherein said durable component comprises a peristaltic pump and a pinch valve, and wherein said single-use component comprises a tubing harness comprising a plurality of reagent inlets, a fluid outlet, and a chromatography column.

2. The chromatography system of claim 1, wherein said tubing harness further comprises a pressure sensor.

3. The chromatography system of claim 1, wherein said tubing harness further comprises a pH sensor.

4. The chromatography system of claim 1, wherein said tubing harness further comprises a conductivity sensor.

5. The chromatography system of claim 1, wherein said tubing harness further comprises a detection flow cell.

6. The chromatography system of claim 5, wherein said detection flow cell comprises a UV detection flow cell.

7. The chromatography system of claim 1, wherein said durable component comprises a single peristaltic pump.

8. The chromatography system of claim 1, wherein said durable component further comprises a centralized control system.

9. The chromatography system of claim 8, wherein at least one pinch valve is controlled by said centralized control system.

10. The chromatography system of claim 8, wherein said peristaltic pump is controlled by said centralized control system.

11. The chromatography system of claim 1, wherein said durable component further comprises an optical detector.

12. The chromatography system of claim 11, wherein said optical detector detects in a light range comprising the UV range.

13. The chromatography system of claim 1, wherein said durable component further comprises a pH sensor.

14. The chromatography system of claim 1, wherein said durable component further comprises a conductivity sensor.

15. A single-use component for a chromatography system comprising a tubing harness, wherein said tubing harness comprises a plurality of reagent inlets, a fluid outlet, and a chromatography column.

16. The single-use component of claim 15, wherein said tubing harness further comprises a pressure sensor.

17. The single-use component of claim 15, wherein said tubing harness further comprises a pH sensor.

18. The single-use component of claim 15, wherein said tubing harness further comprises a conductivity sensor.

19. The single-use component of claim 15, wherein said tubing harness further comprises a detection flow cell.

20. The single-use component of claim 15, wherein said detection flow cell comprises a UV detection flow cell.
